(19) United States
(12) Patent Application Publication
(10) Pub. No.: US 2009/0230352 A1
(43) Pub. Date: Sep. 17, 2009

(54) Composition with high temperature resistance, high chemical resistance and high abrasion resistance

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/381,825

(22) Filed: Mar. 17, 2009

Related U.S. Application Data
(60) Provisional application No. 61/037,284, filed on Mar. 17, 2008.

(51) Int. Cl. C09K 3/00

(52) U.S. Cl. 252/182.33; 252/182.32

(57) ABSTRACT

A composition that when cured possesses high temperature, chemical and abrasion resistance, and which can be formed into shapes, used as binder for aggregate fibers, sand or the like, or used to repair hard surfaces. The composition has a first part that is a slurry of an alkali metal silicate solution, such as lithium silicate, sodium silicate or potassium silicate, alone or in combination, combined with a non-reactive alkali metal, such as a silica flour or powder. The second part of the composition is a mixture of sodium silicofluoride, silica fume and sodium borate. A small amount of boric acid may be added to the second part to slow the curing reaction.

This application claims the benefit of U.S. Provisional Patent Application Ser. No. 61/037,284, filed Mar. 17, 2008.

### BACKGROUND OF THE INVENTION

This invention relates generally to the field of compositions with high temperature, chemical and abrasion resistance, wherein the composition can be formed into stand-alone solid shapes or used to repair hard surfaces. The invention further relates to such compositions that are castable or formable, such that a wet mixture of the composition can cure into a solid shape through evaporation of water from the mixture.

### SUMMARY OF THE INVENTION

The invention is a composition that when cured possesses high temperature, chemical and abrasion resistance, and which can be formed into shapes, used as binder for aggregate fibers, sand or the like, or used to repair hard surfaces. The composition consists essentially of a first part that is a slurry consisting essentially of an alkali metal silicate solution, such as lithium silicate, sodium silicate or potassium silicate, alone or in combination, combined with a non-reactive alkali metal, such as a silica flour or powder. The second part of the composition is a mixture of sodium silicofluoride, silica fume and sodium borate. A small amount of boric acid may be added to the second part to slow the curing reaction. Preferably the first part slurry and second part mixture are combined such that the composition is approximately 95 to 70 wt. percent first part and 5 to 30 wt. percent second part.

### DETAILED DESCRIPTION OF THE INVENTION

The invention is a composition that when cured possesses high temperature, chemical and abrasion resistance, and which can be formed into shapes, used as binder for aggregate fibers, sand or the like, or used to repair hard surfaces. The composition consists essentially of a first part that is a slurry consisting essentially of an alkali metal silicate solution, such as lithium silicate, sodium silicate or potassium silicate, alone or in combination, combined with a non-reactive alkali metal, such as a silica flour or powder. The second part of the composition is a mixture of sodium silicofluoride, silica fume and sodium borate. A small amount of boric acid may be added to the second part to slow the curing reaction. Preferably the first part slurry and second part mixture are combined such that the composition is approximately 95 to 70 wt. percent first part and 5 to 30 wt. percent second part. Most preferably, the composition is approximately 90 wt. percent of the first part 10 wt. percent of the second part.

The alkali metal silicate solutions of the first part consist essentially of approximately 28 to 56 wt. percent of the silicate in approximately 72 to 44 wt. percent water, with the silicate being lithium silicate, sodium silicate or potassium silicate, alone or in combination. The non-reactive alkali metal of the first part is silica flour or powder, preferably at a mesh size equal to or less than 200 mesh. Approximately 60 to 40 wt. percent of the first part is combined with approximately 40 to 60 wt. percent of the second part to form a slurry, with a preferred combination being 50:50.

The second part is a dry mixture consisting essentially of sodium silicofluoride, silica fume and sodium borate. The sodium silicofluoride is present in the second part at approximately 5 to 20 wt. percent, the silica fume is present at approximately 70 to 90 wt. percent, and the sodium borate is present at approximately 5 to 10 wt. percent. Most preferably the sodium silicofluoride is present in the second part at approximately 10 wt. percent, the silica fume is present at approximately 85 wt. percent, and the sodium borate is present at approximately 5 wt. percent. The silica fume is preferably of a mesh size between approximately 200 and 350 mesh. Boric acid in an amount of between approximately 0.5 to 2 wt. percent may be added to the second part in order to slow the reaction or curing time, with a corresponding reduction in the amount of sodium borate present in the second part.

Upon combination of the first and second parts, the composition will harden by evaporation of the water. The composition may be used to form blocks, brake pads or the like. Sand, aggregates, fibers or the like may be added to the composition to improve certain properties or to form a mortar or concrete-like material.

It is contemplated that certain equivalents or substitutions for certain elements set forth above may be obvious to one skilled in the art, and therefore the true scope and definition of the invention is to be as set forth in the following claims.

I claim:

1. A composition having high temperature resistance, high corrosion resistance and high abrasion resistance, said composition consisting essentially of a first part and a second part in combination;
said first part being a slurry consisting essentially of an alkali metal silicate solution combined with a non-reactive alkali metal;
said second part being a dry mixture consisting essentially of the combination of sodium silicofluoride, silica fume and sodium borate.

2. The composition of claim 1, wherein said first part is present at approximately 95 to 70 wt. percent and said second part is present at approximately 5 to 30 wt. percent.

3. The composition of claim 1, wherein said first part is present at approximately 90 wt. percent and said second part is present at approximately 10 wt. percent.

4. The composition of claim 1, wherein said alkali metal silicate solution consists essentially of water and a silicate chosen from the group of silicates including lithium polysilicate, sodium silicate and potassium silicate, alone or in combination.

5. The composition of claim 4, wherein said alkali metal silicate solution is a combination of approximately 72 to 44 wt. percent water and approximately 28 to 56 wt. percent silicate.

6. The composition of claim 5, wherein said first part consists essentially of approximately 40 to 60 wt. percent alkali metal silicate solution and approximately 60 to 40 wt. percent non-reactive alkali metal.

7. The composition of claim 6, wherein said non-reactive alkali metal is silica flour having a mesh size of less than approximately 200 mesh.

8. The composition of claim 1, wherein said second part consists essentially of approximately 5 to 20 wt. percent sodium silicofluoride, approximately 70 to 90 wt. percent silica fume, and approximately 5 to 10 wt. percent sodium borate.

9. The composition of claim 8, wherein said second part further comprises approximately 0.5 to 2 wt. percent boric acid boric acid, and wherein the wt. percent of said sodium borate is reduced by an amount equivalent to the wt. percent of said boric acid.

10. The composition of claim 8, wherein second part consists essentially of approximately 10 wt. percent sodium silicofluoride, approximately 85 wt. percent silica fume, and approximately 5 wt. percent sodium borate.

11. The composition of claim 8, wherein said silica fume is sized between approximately 20 to 350 mesh.

12. The composition of claim 6, wherein said second part consists essentially of approximately 5 to 20 wt. percent sodium silicofluoride, approximately 70 to 90 wt. percent silica fume, and approximately 5 to 10 wt. percent sodium borate.

13. The composition of claim 12, wherein said second part further comprises approximately 0.5 to 2 wt. percent boric acid boric acid, and wherein the wt. percent of said sodium borate is reduced by an amount equivalent to the wt. percent of said boric acid.

14. A composition having high temperature resistance, high corrosion resistance and high abrasion resistance, said composition consisting of a first part and a second part in combination;
said first part being a slurry consisting of an alkali metal silicate solution combined with a non-reactive alkali metal, wherein said alkali metal silicate solution consists of water and a silicate chosen from the group of silicates including lithium polysilicate, sodium silicate and potassium silicate, alone or in combination, and wherein said non-reactive alkali metal is silica flour;
said second part being a dry mixture consisting of the combination of sodium silicofluoride, silica fume and sodium borate;
wherein said first part is present at approximately 95 to 70 wt. percent and said second part is present at approximately 5 to 30 wt. percent.

15. The composition of claim 14, wherein said first part consists of approximately 40 to 60 wt. percent alkali metal silicate solution and approximately 60 to 40 wt. percent non-reactive alkali metal, and wherein said second part consists of approximately 5 to 20 wt. percent sodium silicofluoride, approximately 70 to 90 wt. percent silica fume, and approximately 5 to 10 wt. percent sodium borate.

16. The composition of claim 15, wherein said second part further comprises approximately 0.5 to 2 wt. percent boric acid boric acid, and wherein the wt. percent of said sodium borate is reduced by an amount equivalent to the wt. percent of said boric acid.

17. The composition of claim 16, wherein said alkali metal silicate solution is a combination of approximately 72 to 44 wt. percent water and approximately 28 to 56 wt. percent silicate.

18. The composition of claim 17, wherein said non-reactive alkali metal is silica flour having a mesh size of less than approximately 200 mesh, and wherein said silica fume is sized between approximately 20 to 350 mesh.
